(19) United States
(12) Patent Application Publication
(10) Pub. No.: US 2013/0313105 A1
(43) Pub. Date: Nov. 28, 2013

(54) Method and Device for Treating Opaque Fluids with UV Radiation

(71) Applicant: Eva Alander, Liding (SE)

(72) Inventor: Eva Alander, Liding (SE)

(73) Assignee: WALLENIUS WATER AB, Stockholm (SE)

(21) Appl. No.: 13/880,688

(22) PCT Filed: Oct. 20, 2011
(86) PCT No.: PCT/SE2011/051252

§ 371 Date: Aug. 12, 2013

(30) Foreign Application Priority Data
Oct. 20, 2010 (SE) 1001033-8

(51) Int. Cl. B01J 19/12

(52) U.S. Cl. CPC B01J 19/123
USPC 204/158.2

(57) ABSTRACT

The present invention relates to a method for treating opaque fluids, comprising the steps of placing a treatment unit inside a volume of fluid to be treated, which treatment unit comprises a UV radiation member capable of emitting UV radiation, 5 radiating said volume of fluid with UV radiation, whereby said UV radiation is capable of creating radicals in said fluid, which radicals react with matter in the fluid, thereby treating it.

### TECHNICAL FIELD

The present invention relates to a method for treating liquids and in particular liquids that are opaque. The present invention in particular relates to a method utilizing radiation technologies.

### BACKGROUND OF THE INVENTION

There are a number of devices on the market that are capable of treating, and in particular purifying, liquids. In many instances, members capable of generating UV radiation are used in the treatment process, and in particular UV radiation of certain wave-lengths that can create different reaction components such as ozone, hydrogen peroxide, radicals, to mention a few. In order to increase the performance of the cleaning process, some treatment devices are arranged with catalysts that are capable of creating e.g. photo-catalytic reactions for producing the treatment components.

The above mentioned treatment methods have a good performance when treating liquids that possess a good transmissibility, i.e. the radiation from the UV generating members can spread in the volume to be treated. The more the liquid becomes filled with particles and the like matter increasing the opacity of the liquid, the more difficult it becomes to reach all parts of the volume of liquid to be treated.

One area where treatment and purification of liquid is important is machining where cutting fluids are used. Cutting fluids often comprise an emulsion of oil and water, where the water makes them susceptible to bacteria and other micro-organisms, leading to odours, in turn breaking down of the function of the cutting fluid and clogging of equipment and piping handling the cutting fluid. Further the cutting fluids become increasingly loaded with foreign matter from the machining during use.

Several attempts have been made to purify cutting fluids with technologies involving no chemicals, where some are attempting the use of UV radiation. A major problem in this context is the opacity of the cutting fluid, which is worsened during use by foreign matter such as cutting chips, as well as micro-organism, bacteria and/or fungi growing in the fluid. One such attempt is disclosed in the patent document No. U.S. Pat. No. 6,344,176, wherein cutting fluid is irradiated by UV. In order to be able to cope with the problems of opacity, the cutting fluid is formed as a liquid film on a carrier drum and where UV radiating members are placed adjacent the carrier drum. In this manner the UV radiating members are capable of radiating through the thickness of the film. A major drawback with the device of U.S. Pat. No. 6,344,176 is the limited treatment capacity due to that only thin films can be treated, i.e. very small volumes of cutting fluid, during a time period. Also, the device of U.S. Pat. No. 6,344,176 requires additional floor space in the work shop, which space could otherwise be used for manufacturing purposes.

Another attempt is disclosed in the patent document WO 9962104 where the energy input is increased in order to cope with the poor transmissibility of certain fluids. Here an excimer lamp is utilized, which has a special design through which the fluid to be treated flows. In order to handle the energy input, the excimer lamp is provided with cooling means.

Even though the increased energy input improves the transmission depth in the liquid to be treated, thereby improving the treatment ratio, it still requires a special design of the lamp and its surrounding housing design, and the actual volumes that can be treated with the special design is still rather limited, whereby the treatment process of a complete volume of e.g. cutting fluid is rather time consuming.

Another problem encountered with treatment by UV radiation is that surfaces that protect the UV radiation sources, like quartz glass enclosing the UV lamps get polluted by material and organisms that stick on the surfaces. This fact will drastically reduce the efficiency of the UV lamps over time, and eventually lead to no output at all. The present method of remedying this problem is to stop the treatment process, remove the treatment units and clean the protective glass manually, which is a labor-intensive work. Also the production is stopped during cleaning.

Another problem encountered with treating opaque liquids is that the transmission of UV radiation in the volume of the liquid is poor. Therefore it would be advantageous if a larger part of the volume of liquid is handled such that it is exposed to the UV-treatment.

Thus, there is still room for improvements in the area of treating fluids.

### BRIEF DESCRIPTION OF THE INVENTION

The aim of the present invention is to remedy the drawbacks of the known methods and devices for treating opaque fluids, and in particular fluids containing a degree of biological material such as bacteria and other micro-organisms.

This aim is obtained according to the present invention with a method comprising the features of the independent patent claim. Preferable embodiments of the present invention form the subject of the dependent patent claims.

According to a main aspect of the invention it is characterised by a method for treating opaque fluids, comprising the steps of placing a treatment unit inside a volume of fluid to be treated, which treatment unit comprises a UV radiation member capable of emitting UV radiation, radiating said volume of fluid with UV radiation whereby said UV radiation is capable of creating radicals in said fluid, which radicals react with matter in the fluid, thereby treating it.

According to another aspect of the invention, said UV radiation is capable of creating photo-ionization effects in the fluid.

According to yet another aspect of the invention, said treatment unit further comprises a quartz glass of high purity positioned between said UV radiation member and said fluid to be treated.

According to a further aspect of the invention, said treatment unit further comprises photo-catalytic material placed in the UV radiation for creating photo-catalyzing effects.

According to yet a further aspect of the invention, the photo-catalytic material is arranged on a fluid non-permeable carrier.

Alternatively, the photo-catalytic material is arranged on a fluid permeable carrier.

According to a further aspect of the invention, it further comprises the step of creating a flow in said volume of fluid to be treated.

According to yet an aspect of the invention it further comprises mixing and guiding the flow in said volume by static mixing elements.

According to a preferred aspect, the flow is guided along said UV radiation members.

According to a further aspect of the invention, it further comprises the step of inducing vibrations to the protective surface in order to remove any material stuck on the surface.

According to yet an aspect of the invention, said vibrations are chosen such that it generally corresponds to the natural frequency of the protective surface.

Preferably the vibrations are created by a piezo-electric element.

There are a number of benefits with the present invention. By placing a treatment unit inside a volume of fluid to be treated, no fluid transport or conveyor mechanisms are necessary for the treatment process. By creating radicals, a very powerful treatment mechanism is obtained, capable of handling the fluid in the volume.

An advantage is that the treatment unit is capable of creating photo-ionization effects that are used in the treatment process. Additionally or instead, photo-catalytic effects are used in the treatment process. In either case, the treatment unit is arranged with suitable means for creating the desired treatment components. Also the UV radiation members are arranged such as to emit the proper wave-lengths in order to create and promote the desired treatment components. In order to even further enhance the effect, flows are created in the volume of liquid so that the total volume is exposed to the method and thereby treated.

Another advantage with the present invention is the possibility of using static mixers together with the treatment units. Mixers provide the advantage that a much larger volume of the liquid to be treated will pass the UV radiation close to the UV sources and will thereby be exposed very effectively. Static mixers are preferred because there are no moving parts that need maintenance. Further the mixers may be specific distinct segments like vanes or wings, plane or curved, angled or straight and combinations of these or they may be continuous like spirals encircling the elongated UV sources throughout the enclosures.

A further advantage with the present invention is the use of vibrating element or shakers that are capable of inducing vibrations to the protective surfaces enclosing the UV sources, like the quartz glasses. These vibrations reduce to a very large extent the possibilities for material and organisms to stick to the surfaces. In this aspect the natural frequencies of the protective surfaces, like the quartz glasses have proven to be very efficient frequencies for this purpose.

These and other aspects of and advantages with the present invention will become apparent from the following detailed description and from the accompanying drawing.

### BRIEF DESCRIPTION OF THE DRAWINGS

In the following detailed description of the invention, reference will be made to the accompanying drawings, of which

FIG. 1 is a schematic side view of a treatment unit used in the present invention.

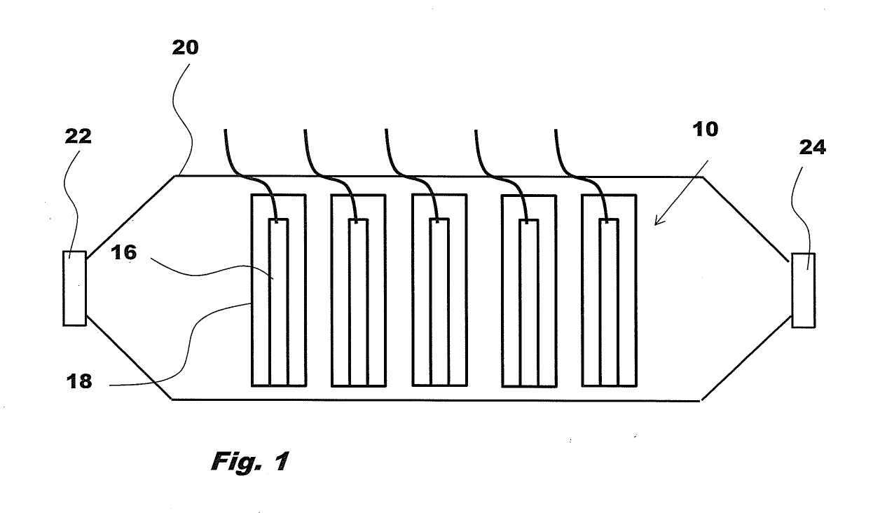

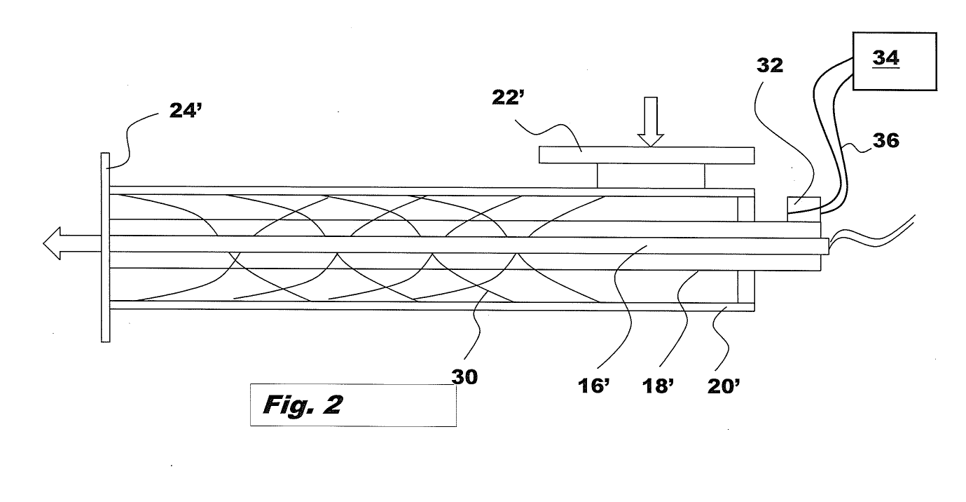

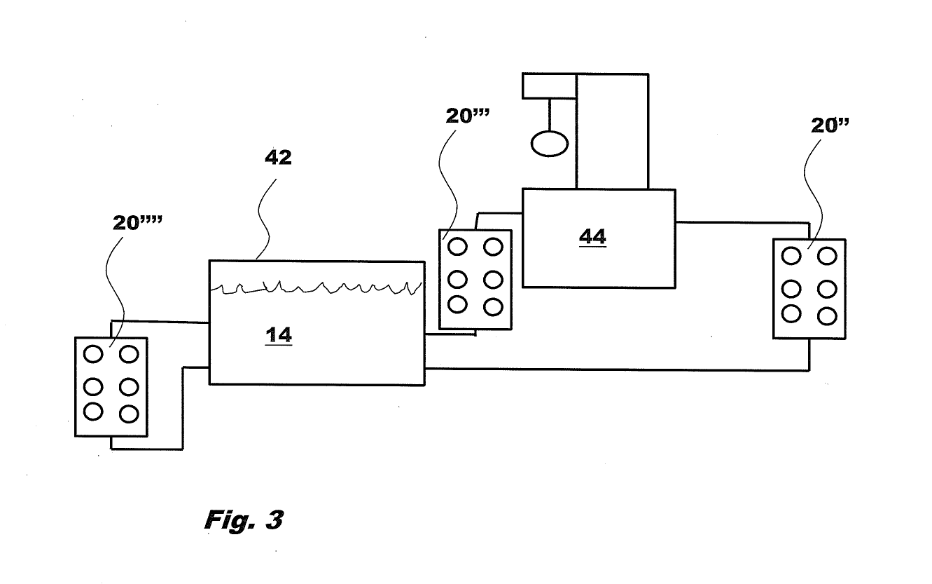

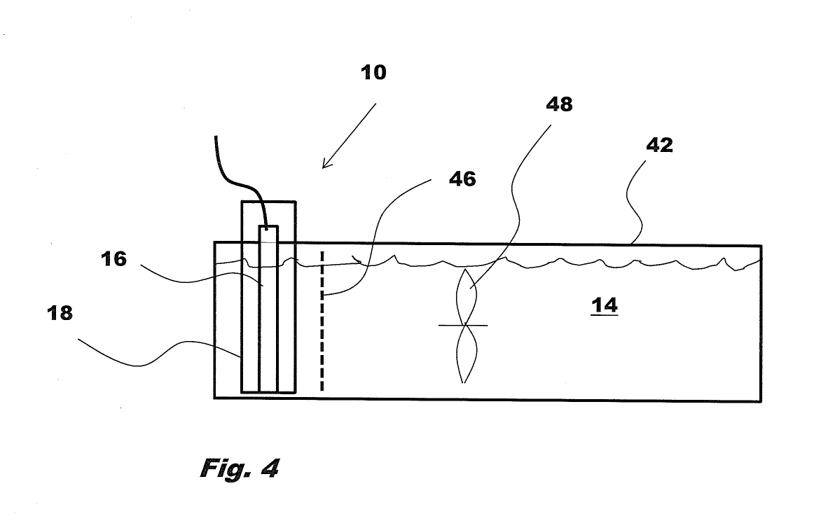

### DETAILED DESCRIPTION OF THE INVENTION

The present invention relates to a method of treating fluids, and in particular fluids that are opaque.

According to the invention shown in the drawing, a treatment unit 10 is arranged. The treatment unit 10 comprises at least one radiation source 16 capable of creating radiation energy in the liquid. The radiation source is preferably capable of creating radiation in the UV region, due to the positive effects that UV radiation possess. In order to create a good treatment environment and in order to maximize the treatment efficiency of the UV radiation, different measures are provided. One such measure for the treatment unit 10 is to position a transparent glass cover 18 or wall between the UV radiation source 16 and the fluid 14 to be treated. In order to create a desired photo-ionisation effect, which is very effective in treating the liquid, the glass cover 18 is made of very pure quartz glass. Preferred wavelengths are in the region of 100 nm to 220 nm, with preferable peaks between 170-190 nm. These highly energetic wavelengths are absorbed by water molecules, causing homolysis of the water molecules with the formation of hydrogen atoms and hydroxyl radicals. The process will create radicals having highly oxidizing effects, which are used for breaking down and decomposing any organic or biological material in the fluid.

According to one aspect of the invention, the treatment unit, or preferably several treatment units 10, are placed in an enclosure or reactor 20, having an inlet 22 and an outlet 24 for the liquid to be treated to flow through the enclosure. The treatment units 10 are then positioned such in the enclosure that preferably the total volume of liquid is exposed to UV radiation in order that the photo-ionisation occurs throughout the volume.

Further, the reactor may be arranged with static mixers that are capable of guiding and mixing the flow through the reactor such that the fluid is fully exposed to the UV radiation and in particular that all volumes of the liquid to be treated are passing within the UV treatment zones of the lamps.

An alternative reactor is shown in FIG. 2, comprising a generally elongated tube or enclosure 20′, creating a treatment space and having an inlet 22′ and an outlet 24′. In this aspect, as seen in FIG. 2, the UV lamp 16′ may be arranged inside elongated quartz glass enclosure or cover 18′ and wherein they extend in the direction of the flow, i.e. the extension of the lamps coincide with the general flow of liquid. Static mixer elements 30 may then be placed in the vicinity of the lamps, capable of guiding the flow along the lamp enclosures at the same time as the liquid is mixed. This increases the rate of exposure to UV radiation of all volumes of liquid passing by the lamps, due to the mixers. The mixer elements may have many different designs depending on the desired and intended function and output. They can be separate distinct plates that are either planar or curved or continuous plates along the length of the lamps, like e.g. spirals or similar curved shapes.

According to the present invention, a vibration unit 32, FIG. 2, may further be connected to the quartz glass, preferably outside the treatment space. The vibration unit 32 is connected to a power drive source 34 via leads 36. When activated, the vibration unit is capable of inducing vibrations in the glass tube with an appropriate frequency and amplitude that will make any material stuck on the outer surface of the glass to be removed. One range of frequencies of the vibrations may be the natural frequency of the quartz glass cover, where the natural frequency will effectively prevent any material or organisms to stick on the surface. One preferable vibration unit is a piezo-electric element capable of producing vibrations with very little power input.

Depending on the specific application and size of the cleaning units and thus the glass tubes, larger and/or a plurality of vibration units may be required. Also the position of the vibration units may be varied in order to produce the best result.

According to FIG. 3, the treatment reactor 20 can be placed in a normal loop for the liquid between a storage tank 42 and a cutting machine 44 such as a lathe, a miller, and the like, either before 20″ or after 20′″ the cutting machine. It is also feasible to only have a separate loop with the reactor 20″″ connected to the tank 12 where the liquid is circulated and treated in the reactor.

As an alternative, one or several treatment units can be positioned directly in the tank 42 containing fluid 14 to be treated, FIG. 4. The volume 42 could e.g. be a compartment which is common in a cutting machine, where cutting fluid is used during machining for cooling and lubricating the machining process.

As an extra feature, also creation of radicals by photo-catalytic processes is very effective for treating fluids. Hereby catalytic material is placed in the vicinity of the UV radiation sources such that the material is radiated, FIG. 4. The presence of photocatalytic material increases or creates decomposing radicals. The photo-catalytic material could be placed on suitable carriers 46 such as metal plates, meshes or even attached to the surface of the surrounding glass. Suitable photo-catalytic materials include noble metals, TiO2, SiO2, just to mention some.

When a number of such units are placed in the volume of liquid to be treated, a thorough treatment effect is obtained throughout the volume, cleaning the fluid and removing any organic material. Additional functions may include stirrers 48, and/or baffles that create and control flows in the fluid to be treated, either in the reactor or in the tank containing the liquid.

It is to be understood that the embodiments described above and shown in the drawings are to be regarded only as non-limiting examples of the invention and that it may be modified in many ways within the scope of the patent claims.

1-13. (canceled)

14. A method of treating opaque fluids, comprising:
placing a treatment unit inside a volume of fluid to be treated, which treatment unit comprises an ultraviolet (UV) radiation member configured to emit UV radiation; and
radiating the volume of fluid with UV radiation, whereby the UV radiation is configured to create radicals in the fluid that react with matter in the fluid, thereby treating it.

15. The method of claim 14, wherein the UV radiation is configured to create photo-ionization effects in the fluid.

16. The method of claim 15, wherein the treatment unit further comprises a quartz glass positioned between the UV radiation member and the fluid to be treated.

17. The method of claim 14, wherein the treatment unit further comprises a photo-catalytic material placed in the UV radiation for creating photo-catalyzing effects.

18. The method of claim 17, wherein the photo-catalytic material is arranged on a fluid-non-permeable carrier.

19. The method of claim 17, wherein the photo-catalytic material is arranged on a fluid-permeable carrier.

20. The method of claim 14, further comprising creating a flow in the volume of fluid to be treated.

21. The method of claim 20, further comprising mixing and guiding the flow in the volume by static mixing elements.

22. The method of claim 21, wherein the flow is guided along the UV radiation members.

23. The method of claim 14, further comprising inducing vibrations on a protective surface in order to remove material stuck on the protective surface.

24. The method of claim 23, wherein the vibrations are such that they generally correspond to a natural frequency of the protective surface.

25. The method of claim 23, wherein the vibrations are induced by a piezo-electric element.

26. A device for treating opaque fluids, comprising:
a treatment unit configured for placement inside a volume of fluid to be treated, wherein the treatment unit includes an ultraviolet (UV) radiation member configured to radiate the volume of fluid with UV radiation such that the UV radiation creates radicals in the fluid that react with matter in the fluid, thereby treating it.

27. The device of claim 26, wherein the treatment unit further comprises a quartz glass positioned between the UV radiation member and the fluid to be treated.

28. The device of claim 26, wherein the treatment unit further comprises a photo-catalytic material placed in the UV radiation for creating photo-catalyzing effects in the volume of fluid.

29. The device of claim 28, wherein the photo-catalytic material is arranged on a fluid-non-permeable carrier.

30. The device of claim 28, wherein the photo-catalytic material is arranged on a fluid-permeable carrier.

31. The device of claim 26, further comprising static mixing elements configured for mixing and guiding a flow in the volume of fluid to be treated.

32. The device of claim 31, wherein the flow is guided along the UV radiation members.

33. The device of claim 26, further comprising a vibration induction device configured to induce vibrations on a protective surface in order to remove material stuck on the protective surface.
